(19) United States
(12) Patent Application Publication
(10) Pub. No.: US 2024/0013365 A9
(43) Pub. Date: Jan. 11, 2024

(54) UNSUPERVISED OR SELF-SUPERVISED DEEP LEARNING FOR SEMICONDUCTOR-BASED APPLICATIONS

(71) Applicant: KLA Corporation, Milpitas, CA (US)

(72) Inventors: Jing Zhang, Santa Clara, CA (US); Rajkumar Theagarajan, Milpitas, CA (US); Yujie Dong, Newark, CA (US); John Song, Milpitas, CA (US); Kris Bhaskar, San Jose, CA (US)

(21) Appl. No.: 17/671,519

(22) Filed: Feb. 14, 2022

Related U.S. Application Data
(60) Provisional application No. 63/251,705, filed on Oct. 4, 2021.

(51) Int. Cl. G06T 7/00

(52) U.S. Cl. CPC G06T 7/0004; G06T 2207/20081; G06T 2207/20084; G06T 2207/30148

(57) ABSTRACT

Methods and systems for determining information for a specimen are provided. One system includes a computer subsystem and one or more components executed by the computer subsystem that include a deep learning (DL) model trained without labeled data (e.g., in an unsupervised or self-supervised manner) and configured to generate a reference for a specimen from one or more inputs that include at least a specimen image or data generated from the specimen image. The computer subsystem is configured for determining information for the specimen from the reference and at least the specimen image or the data generated from the specimen image.

### BACKGROUND OF THE INVENTION

### 1. Field of the Invention

The present invention generally relates to methods and systems for determining information for a specimen. Certain embodiments relate to a deep learning model trained without labeled data, e.g., in an unsupervised or self-supervised manner, and configured to generate a reference for a specimen from one or more inputs that include at least a specimen image or data generated from the specimen image.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Many different kinds of algorithms are currently used with the processes described above and vary depending on the process itself, the specimen, and the information being determined for it. Different kinds of such algorithms can be separated into different categories in a variety of ways such as those that are deep learning based and those that are not. In an inspection example, some non-deep learning defect detection algorithms are unsupervised and use a frequency measure on marginal or joint probability. One example of a non-deep learning defect detection algorithm that is used by some inspection tools commercially available from KLA Corp., Milpitas, Calif. is the multiple-die auto-thresholding (MDAT) algorithm. Unlike such algorithms, machine learning or deep learning empowered supervised detection may be performed via a convolutional neural network (CNN) or object detection networks.

While many of the algorithms described above have proved useful in the field to varying degrees, there can still be a handful of disadvantages to such methods that leave room for improvement. For example, many of the non-deep learning defect detection algorithms are difficult to be applied to multi-mode or multi-perspective data inputs. Having the ability to utilize multi-mode or multi-perspective data inputs is becoming increasingly important as tools are being pushed to exceed their best performance achievable using only single mode data. In another example, the machine learning or deep learning defect detection methods described above can require a substantially large training dataset, which is not always practically obtainable or can incur substantially high cost of ownership in terms of time to results and physical expense (like wafers or other specimens).

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured to determine information for a specimen. The system includes a computer subsystem and one or more components executed by the computer subsystem that include a deep learning (DL) model trained without labeled data and configured to generate a reference for a specimen from one or more inputs that include at least a specimen image or data generated from the specimen image. The computer subsystem is configured for determining information for the specimen from the reference and at least the specimen image or the data generated from the specimen image. The system may be further configured as described herein.

Another embodiment relates to a computer-implemented method for determining information for a specimen. The method includes generating a reference for a specimen by inputting one or more inputs into a DL model trained without labeled data. The one or more inputs include at least a specimen image or data generated from the specimen image. The method also includes determining information for the specimen from the reference and at least the specimen image or the data generated from the specimen image. The inputting and determining steps are performed by a computer subsystem. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 1a are schematic diagrams illustrating side views of embodiments of a system configured as described herein;

FIGS. 2-3 are flow charts illustrating embodiments of steps that may be performed for determining information for a specimen; and

FIG. 4 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for determining information for a specimen for inspection applications, e.g., detecting defects on a specimen, and/or other semiconductor-based applications such as metrology and defect review via learning a reference such as a reference image or structural noises for the specimen.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

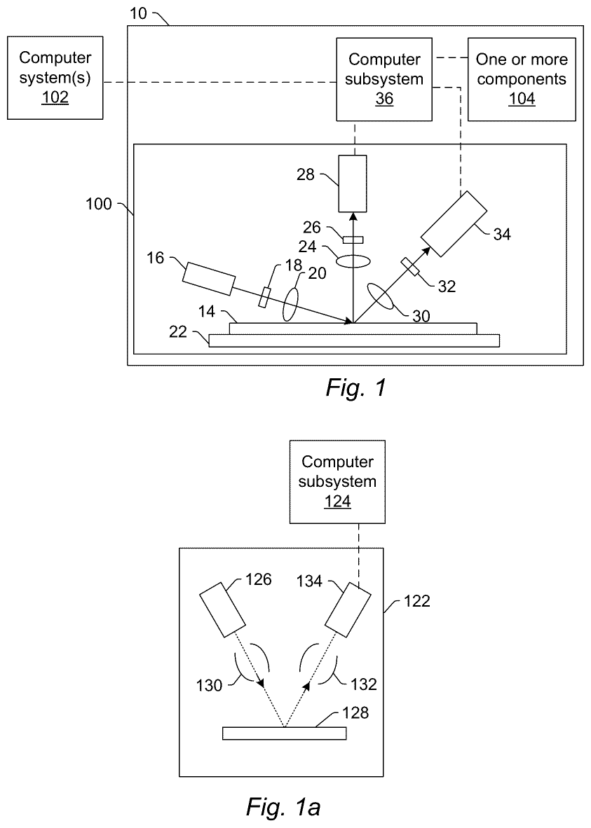

One embodiment of a system configured for determining information for a specimen is shown in FIG. 1. In some embodiments, system 10 includes an imaging subsystem such as imaging subsystem 100. The imaging subsystem includes and/or is coupled to a computer subsystem, e.g., computer subsystem 36 and/or one or more computer systems 102.

In general, the imaging subsystems described herein include at least an energy source, a detector, and a scanning subsystem. The energy source is configured to generate energy that is directed to a specimen by the imaging subsystem. The detector is configured to detect energy from the specimen and to generate output responsive to the detected energy. The scanning subsystem is configured to change a position on the specimen to which the energy is directed and from which the energy is detected. In one embodiment, as shown in FIG. 1, the imaging subsystem is configured as a light-based imaging subsystem. In this manner, the specimen images described herein may be generated by a light-based imaging subsystem.

In the light-based imaging subsystems described herein, the energy directed to the specimen includes light, and the energy detected from the specimen includes light. For example, in the embodiment of the system shown in FIG. 1, the imaging subsystem includes an illumination subsystem configured to direct light to specimen 14. The illumination subsystem includes at least one light source. For example, as shown in FIG. 1, the illumination subsystem includes light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the process being performed on the specimen.

The illumination subsystem may be configured to direct the light to the specimen at different angles of incidence at different times. For example, the imaging subsystem may be configured to alter one or more characteristics of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence.

In some instances, the imaging subsystem may be configured to direct light to the specimen at more than one angle of incidence at the same time. For example, the illumination subsystem may include more than one illumination channel, one of the illumination channels may include light source 16, optical element 18, and lens 20 as shown in FIG. 1 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the illumination subsystem may include only one light source (e.g., source 16 shown in FIG. 1) and light from the light source may be separated into different optical paths (e.g., based on wavelength, polarization, etc.) by one or more optical elements (not shown) of the illumination subsystem. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, optical element 18 may be configured as a spectral filter and the properties of the spectral filter can be changed in a variety of different ways (e.g., by swapping out one spectral filter with another) such that different wavelengths of light can be directed to the specimen at different times. The illumination subsystem may have any other suitable configuration known in the art for directing light having different or the same characteristics to the specimen at different or the same angles of incidence sequentially or simultaneously.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). The laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. In instances in which the light is scanned over the specimen, the light may be scanned over the specimen in any suitable fashion such as in a serpentine-like path or in a spiral path.

The imaging subsystem further includes one or more detection channels. At least one of the detection channel(s) includes a detector configured to detect light from the specimen due to illumination of the specimen by the imaging subsystem and to generate output responsive to the detected light. For example, the imaging subsystem shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

As further shown in FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). In one such instance, the detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels has its own collector, each of which is configured to collect light at different scattering angles than each of the other collectors.

As described further above, each of the detection channels included in the imaging subsystem may be configured to detect scattered light. Therefore, the imaging subsystem shown in FIG. 1 may be configured for dark field (DF) imaging of specimens. However, the imaging subsystem may also or alternatively include detection channel(s) that are configured for bright field (BF) imaging of specimens. In other words, the imaging subsystem may include at least one detection channel that is configured to detect light specularly reflected from the specimen. Therefore, the imaging subsystems described herein may be configured for only DF, only BF, or both DF and BF imaging. Although each of the collectors are shown in FIG. 1 as single refractive optical elements, each of the collectors may include one or more refractive optical elements and/or one or more reflective optical elements.

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the imaging subsystem may be signals or data, but not image signals or image data. In such instances, a computer subsystem such as computer subsystem 36 may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

It is noted that FIG. 1 is provided herein to generally illustrate a configuration of an imaging subsystem that may be included in the system embodiments described herein. Obviously, the imaging subsystem configuration described herein may be altered to optimize the performance of the imaging subsystem as is normally performed when designing a commercial imaging system. In addition, the systems described herein may be implemented using an existing system (e.g., by adding functionality described herein to an existing inspection system) such as the 29xx/39xx series of tools that are commercially available from KLA Corp., Milpitas, Calif. For some such systems, the methods described herein may be provided as optional functionality of the system (e.g., in addition to other functionality of the system). Alternatively, the system described herein may be designed “from scratch” to provide a completely new system.

Computer subsystem 36 may be coupled to the detectors of the imaging subsystem in any suitable manner (e.g., via one or more transmission media, which may include “wired” and/or “wireless” transmission media) such that the computer subsystem can receive the output generated by the detectors. Computer subsystem 36 may be configured to perform a number of functions using the output of the detectors. For instance, if the system is configured as an inspection system, the computer subsystem may be configured to detect events (e.g., defects and potential defects) on the specimen using the output of the detectors. Detecting the events on the specimen may be performed as described further herein.

Computer subsystem 36 may be further configured as described herein. For example, computer subsystem 36 may be configured to perform the steps described herein. As such, the steps described herein may be performed “on-tool,” by a computer subsystem that is coupled to or part of an imaging subsystem. In addition, or alternatively, computer system(s) 102 may perform one or more of the steps described herein. Therefore, one or more of the steps described herein may be performed “off-tool,” by a computer system that is not directly coupled to an imaging subsystem.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

Although the imaging subsystem is described above as being an optical or light-based imaging subsystem, in another embodiment, the imaging subsystem is configured as an electron beam imaging subsystem. In this manner, the specimen images described herein may be generated by an electron beam imaging subsystem. In an electron beam imaging subsystem, the energy directed to the specimen includes electrons, and the energy detected from the specimen includes electrons. In one such embodiment shown in FIG. 1a, the imaging subsystem includes electron column 122, and the system includes computer subsystem 124 coupled to the imaging subsystem. Computer subsystem 124 may be configured as described above. In addition, such an imaging subsystem may be coupled to another one or more computer systems in the same manner described above and shown in FIG. 1.

As also shown in FIG. 1a, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 1a as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to detect events on the specimen using output generated by detector 134, which may be performed as described further herein. Computer subsystem 124 may be configured to perform any additional step(s) described herein. A system that includes the imaging subsystem shown in FIG. 1a may be further configured as described herein.

It is noted that FIG. 1a is provided herein to generally illustrate a configuration of an electron beam imaging subsystem that may be included in the embodiments described herein. As with the optical imaging subsystem described above, the electron beam imaging subsystem configuration described herein may be altered to optimize the performance of the imaging subsystem as is normally performed when designing a commercial system. In addition, the systems described herein may be implemented using an existing system (e.g., by adding functionality described herein to an existing system) such as tools that are commercially available from KLA. For some such systems, the methods described herein may be provided as optional functionality of the system (e.g., in addition to other functionality of the system). Alternatively, the system described herein may be designed “from scratch” to provide a completely new system.

Although the imaging subsystem is described above as being a light or electron beam imaging subsystem, the imaging subsystem may be an ion beam imaging subsystem. Such an imaging subsystem may be configured as shown in FIG. 1a except that the electron beam source may be replaced with any suitable ion beam source known in the art. In addition, the imaging subsystem may include any other suitable ion beam imaging system such as those included in commercially available focused ion beam (FIB) systems, helium ion microscopy (HIM) systems, and secondary ion mass spectroscopy (SIMS) systems.

As further noted above, the imaging subsystem may be configured to have multiple modes. In general, a “mode” is defined by the values of parameters of the imaging subsystem used to generate output for the specimen. Therefore, modes that are different may be different in the values for at least one of the imaging parameters of the imaging subsystem (other than position on the specimen at which the output is generated). For example, for a light-based imaging subsystem, different modes may use different wavelengths of light. The modes may be different in the wavelengths of light directed to the specimen as described further herein (e.g., by using different light sources, different spectral filters, etc. for different modes). In another embodiment, different modes may use different illumination channels. For example, as noted above, the imaging subsystem may include more than one illumination channel. As such, different illumination channels may be used for different modes.

The multiple modes may also be different in illumination and/or collection/detection. For example, as described further above, the imaging subsystem may include multiple detectors. Therefore, one of the detectors may be used for one mode and another of the detectors may be used for another mode. Furthermore, the modes may be different from each other in more than one way described herein (e.g., different modes may have one or more different illumination parameters and one or more different detection parameters). In addition, the multiple modes may be different in perspective, meaning having either or both of different angles of incidence and angles of collection, which are achievable as described further above. The imaging subsystem may be configured to scan the specimen with the different modes in the same scan or different scans, e.g., depending on the capability of using multiple modes to scan the specimen at the same time.

In some instances, the systems described herein may be configured as inspection systems. However, the systems described herein may be configured as another type of semiconductor-related quality control type system such as a defect review system and a metrology system. For example, the embodiments of the imaging subsystems described herein and shown in FIGS. 1 and 1a may be modified in one or more parameters to provide different imaging capability depending on the application for which they will be used. In one embodiment, the imaging subsystem is configured as an electron beam defect review subsystem. For example, the imaging subsystem shown in FIG. 1a may be configured to have a higher resolution if it is to be used for defect review or metrology rather than for inspection. In other words, the embodiments of the imaging subsystem shown in FIGS. 1 and 1a describe some general and various configurations for an imaging subsystem that can be tailored in a number of manners that will be obvious to one skilled in the art to produce imaging subsystems having different imaging capabilities that are more or less suitable for different applications.

As noted above, the imaging subsystem may be configured for directing energy (e.g., light, electrons) to and/or scanning energy over a physical version of the specimen thereby generating actual images for the physical version of the specimen. In this manner, the imaging subsystem may be configured as an “actual” imaging system, rather than a “virtual” system. However, a storage medium (not shown) and computer subsystem(s) 102 shown in FIG. 1 may be configured as a “virtual” system. In particular, the storage medium and the computer subsystem(s) are not part of imaging subsystem 100 and do not have any capability for handling the physical version of the specimen but may be configured as a virtual inspector that performs inspection-like functions, a virtual metrology system that performs metrology-like functions, a virtual defect review tool that performs defect review-like functions, etc. using stored detector output. Systems and methods configured as “virtual” systems are described in commonly assigned U.S. Pat. No. 8,126,255 issued on Feb. 28, 2012 to Bhaskar et al., U.S. Pat. No. 9,222,895 issued on Dec. 29, 2015 to Duffy et al., and U.S. Pat. No. 9,816,939 issued on Nov. 14, 2017 to Duffy et al., which are incorporated by reference as if fully set forth herein. The embodiments described herein may be further configured as described in these patents. For example, a computer subsystem described herein may be further configured as described in these patents.

The system includes a computer subsystem, which may include any configuration of any of the computer subsystem(s) or system(s) described above, and one or more components executed by the computer subsystem. For example, as shown in FIG. 1, the system may include computer subsystem 36 and one or more components 104 executed by the computer subsystem. The one or more components may be executed by the computer subsystem as described further herein or in any other suitable manner known in the art. At least part of executing the one or more components may include inputting one or more inputs, such as images, data, etc., into the one or more components. The computer subsystem may be configured to input any images, data, etc. into the one or more components in any suitable manner.

The one or more components include a deep learning (DL) model trained without labeled data and configured to generate a reference for a specimen from one or more inputs that include at least a specimen image or data generated from the specimen image. “Trained without labeled data” as that phrase is used herein is defined as being trained at least initially or even completely without data that is labeled in any manner. For example, a first step of the training may be a kind of pre-training based on only unlabeled images, meaning that the training is performed based on only the information contained in the data itself.

This first step of training may also be referred to as a pretext or auxiliary task, that is different from the task that the DL model will ultimately used for, i.e., its “downstream tasks.” In one such example, the pretext or auxiliary task may be taking an unlabeled image, selecting and cropping two or more patches from the image, and then “learning” the relative position(s) of those patches in the original image. In this manner, the labels that are learned during this training step are from the data itself, i.e., where in the images the cropped patches are located, rather than a source external to the data such as a human generated label.

The features learned during this phase may then be used for training the DL model for the tasks the DL model is configured for such as object detection or semantic segmentation. This second step of training, a kind of transfer learning or fine-tuning step, may also be performed without labeled data (i.e., unsupervised learning) or based on a labeled dataset (i.e., self-supervised learning) that is substantially smaller (10×-100× smaller) than that which would be required if all of the training of the DL model was supervised. Enabling training with a substantially smaller dataset is particularly important for the embodiments described herein since unlike consumer-based applications (like learning to differentiate between a person and a car), a substantially large training dataset can often be hard to generate due to the general dearth of good example images (e.g., as in when defects of interest (DOIs) are few and far between especially during the setup phase for an inspection process).

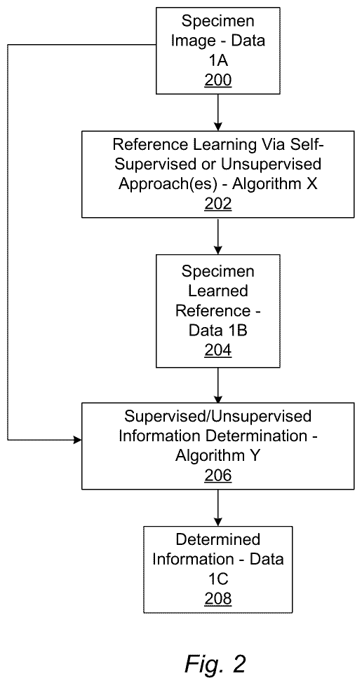

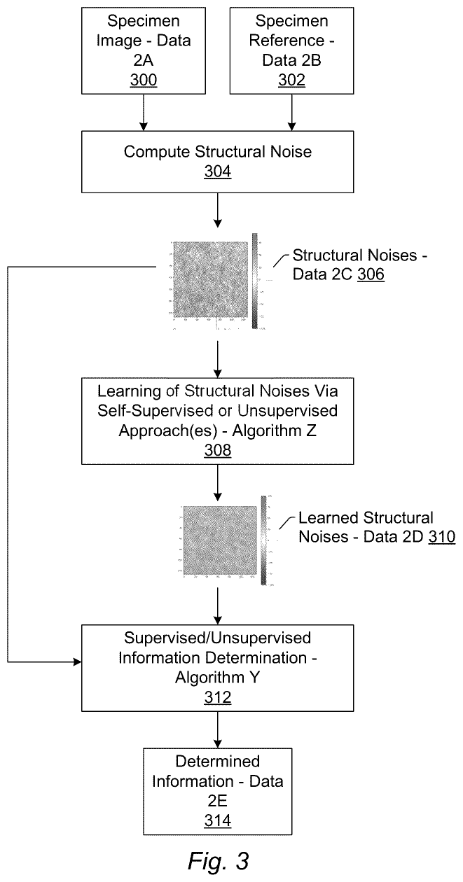

In one embodiment, the DL model is trained in an unsupervised manner. For example, the training described above and further herein is unsupervised when all of the training steps are performed without labeled data. In another embodiment, the DL model is trained in a self-supervised manner. Self-supervised training is a branch of machine learning (ML) that uses unlabeled data to train DL models. For example, the training described above and further herein is self-supervised when at least the initial training step is performed without labeled data. Algorithm X (and algorithm Z) described further herein and shown in FIGS. 2 and 3, respectively, can be selected as a generative adversarial network (GAN), Pixel Convolutional Neural Network (PixelCNN), generative model, etc. A PixelCNN may be trained in a self-supervised manner, and an auto-encoder or generative model may be trained in a self-supervised or unsupervised manner.

A GAN can be generally defined as a deep neural network architecture that includes two networks pitted against each other. Additional description of the general architecture and configuration of GANs and conditional GANs (cGANs) can be found in U.S. Patent Application Publication No. 2021/0272273 by Brauer published Sep. 2, 2021, U.S. patent application Ser. No. 17/308,878 by Brauer et al. filed May 5, 2021, “Generative Adversarial Nets,” Goodfellow et al., arXiv:1406.2661, Jun. 10, 2014, 9 pages, “Semi-supervised Learning with Deep Generative Models,” Kingma et al., NIPS 2014, Oct. 31, 2014, pp. 1-9, “Conditional Generative Adversarial Nets,” Mirza et al., arXiv:1411.1784, Nov. 6, 2014, 7 pages, “Adversarial Autoencoders,” Makhzani et al., arXiv:1511.05644v2, May 25, 2016, 16 pages, and “Image-to-Image Translation with Conditional Adversarial Networks,” Isola et al., arXiv:1611.07004v2, Nov. 22, 2017, 17 pages, which are incorporated by reference as if fully set forth herein. The embodiments described herein may be further configured as described in these references.

PixelCNN is an architecture that is a fully convolutional network of layers that preserves the spatial resolution of its input throughout the layers and outputs a conditional distribution at each location. Examples of PixelCNNs that can be used in the embodiments described herein are included in “Pixel Recurrent Neural Networks,” van den Oord et al., arXiv:1601.06759, Aug. 19, 2016, 11 pages, which is incorporated by reference as if fully set forth herein. The embodiments described herein may be further configured as described in this reference.

A “generative” model can be generally defined as a model that is probabilistic in nature. In other words, a “generative” model is not one that performs forward simulation or rule-based approaches and, as such, a model of the physics of the processes involved in generating an actual image is not necessary. Instead, as described further herein, the generative model can be learned (in that its parameters can be learned) based on a suitable training set of data. The generative model may be configured to have a DL architecture, which may include multiple layers that perform a number of algorithms or transformations. The number of layers included in the generative model may be use case dependent. For practical purposes, a suitable range of layers is from 2 layers to a few tens of layers. Deep generative models that learn the joint probability distribution (mean and variance) between the inputs and outputs described herein can be configured as described further herein and in U.S. Pat. No. 10,395,356 to Zhang et al. issued Aug. 27, 2019, which is incorporated by reference as if fully set forth herein. The embodiments described herein may be further configured as described in this patent.

In one construction, the DL model is trained in a stand-alone fashion in order to learn the low frequency structures of the data. Given the input data X, latent space vector H(X), and output reconstructed data X_{R}, the generator can be trained in a self-supervised or unsupervised fashion using either one or a combination of self-supervised loss functions L(X, X_{R}) such as Mean Squared Error (MSE) loss, Siamese loss, contrastive loss, etc. For example, during training, any one or more of the possible inputs to the DL model described further herein may be input to the DL model to learn a DL model to predict a reference. The reference or its derivative(s) may be in both input and expected output, which is common in self-supervised or unsupervised algorithms. In one such example, when the reference being predicted is a reference image, the training inputs can be any of the following: a specimen test image, a specimen test image and a corresponding reference image, and design information for the specimen with either a specimen test image or a reference image. The inputs can then be used to predict itself in a self-supervised or unsupervised manner. Additional constraints can be added to the latent space vector to make sure that the features learned are all orthogonal to each other similar to Principal Component Analysis (PCA). This can be achieved by multiplying the latent space vector with its transpose as inputs along with the identity matrix (I) to the MSE loss. L_{Orth}=(H(X)^{T}*H(X), I). The training can be stopped if the loss function and other validation metrics do not improve after N number of epochs (early stopping).

Any of the training described above may be performed by one or more computer subsystems included in the embodiments described herein. In this manner, the embodiments described herein may be configured for performing one or more setup or training functions for the DL model. However, any of the training described above may be performed by another method or system (not shown), and that other method or system may make the trained DL model accessible to the embodiments described herein. In this manner, the embodiments described herein may be configured for training the DL model described further herein and for performing runtime functions like using the trained DL model for determining information for one or more runtime specimens which may be the same or different than the setup specimen(s).

In one embodiment, when the one or more inputs include the specimen image, the reference includes a learned reference image. In this manner, the DL model may directly learn a reference via self-supervised or unsupervised learning. In particular, the embodiments described herein may be configured for directly learning non-defective patterns for defect detection (or another application described herein) on wafer or reticle images. One such embodiment is shown in FIG. 2. For example, specimen image (also referred to herein as “data 1A”) 200 is input to reference learning via self-supervised or unsupervised approach(es) (also referred to herein as “algorithm X”) step 202. In this embodiment then, the DL model is also referred to as “algorithm X.”

Specimen image 200 may be a wafer or reticle image or an image of another specimen described herein. The image may be generated by one of the imaging subsystems described herein and acquired by the computer subsystem in any suitable manner. The computer subsystem may input the specimen image into reference learning step 202 in any suitable manner. This image will contain relatively sparse defect signals in most inspection use cases. In other words, if there are defects present on the specimen in the area in which the specimen image was generated, then the specimen image will contain defect signals corresponding to those defects. As such, the defect signals in the specimen image will vary depending on the defects present on the specimen. Other signals in the specimen image may also vary depending on any patterned features formed on the specimen, any nuisance or noise sources on the specimen, etc.

Through algorithm X, specimen learned reference (also referred to herein as “data 1B”) 204 can be learned and computed from data 1A. The difference between data 1A and data 1B is that the properly learned data 1B does not contain primary defect signals from a statistical perspective. Data 1A and Data 1B can then be input to supervised or unsupervised information determination step 206 (also referred to herein as “algorithm Y”), which generates determined information 208 (also referred to herein as “data 1C”). Step 206, algorithm Y, and data 1C may be further configured as described herein.

In another embodiment, when the one or more inputs include the data generated from the specimen image and the data generated from the specimen image includes structural noises, the reference includes learned structural noises. In this manner, the embodiments described herein may be configured for learning structural noises via self-supervised learning. In particular, the embodiments described herein may be configured for learning non-defective structural noise for applications such as defect detection on wafer or reticle images. In one such embodiment shown in FIG. 3, specimen image 300 (also referred to herein as “data 2A”) and specimen reference 302 (also referred to herein as “data 2B”) may be input to compute structural noise step 304, which may compute structural noises 306 (also referred to herein as “data 2C”) from data 2A and data 2B.

Specimen image 300 may be a wafer or reticle image or an image of another specimen described herein. The image may be generated and acquired as described further herein. The computer subsystem may input the specimen image into compute structural noise step 304 step in any suitable manner. This image will contain relatively sparse defect signals in most inspection use cases, and the signals in this image may vary as described above.

Specimen reference 302 may be any suitable reference image, which may be generated as shown in FIG. 2 or by any other suitable (DL or non-DL) method known in the art. For example, specimen reference 302 may simply be an image of an area on a specimen corresponding to the area in which specimen image 300 was generated. Specimen reference 302 may be generated by modifying or combining one or more images (e.g., by filtering, averaging, etc.) corresponding to the specimen image (and possibly including the specimen image). In another example, specimen reference 302 may be generated by the DL reference learning step shown in FIG. 2 or by another suitable DL or ML method known in the art. For example, a DL or ML method may be configured to generate a reference image from design information for the specimen. When specimen reference 302 is generated as shown in FIG. 2, the embodiment shown in FIG. 3 basically adds structural noise calculations in front of that step. The computer subsystem may input the specimen reference image into compute structural noise step 304 step in any suitable manner.

Generating or acquiring the specimen reference is generally performed in a way to minimize any defect signals in the image(s) used as the specimen reference or used to generate the specimen reference. For example, the specimen reference can be obtained by taking the average or median (or other equivalent) of images of two or more neighboring dies/cells, which can advantageously suppress the intensity of the high frequency defective component in the images (but may not eliminate it). In another example, currently used noise suppression techniques like computed reference may be used to generate the specimen reference.

The high frequency defective noise component that cannot be eliminated by this step represents the local structural noise that can be learned by algorithm Z described further below. Learning the high frequency defective noise component may be important for the embodiments described herein. In general, any measured intensity from optics is an additive intensity from both signal and noise. For example, consider a relatively small local signal and a broad/diffused noise at the same location. When the noise is relatively small, what is observed is a peak signal with relatively little background noise. However, when noise is relatively high, what is observed is a relatively little signal with relatively high background noise. This also applies to high frequency noise. Therefore, by constructing/learning the noise component at/around defect locations, we can achieve higher sensitivity by subtracting it from the combined intensity.

Structural noise, as opposed to random noise, is defined herein as a variant optical response or intensity with respect to the nominal optical imaging (also true for other types of imaging). One approximation to structural noise is a difference image, given the reference image is the approximation to nominal optical imaging. In this manner, this embodiment can be thought of as: instead of directly learning a reference image, learning a non-defective image from a “difference” image, which is generated by computing the structural noise. By including a “structural noise calculation” step before algorithm Z in this embodiment, we are giving a priori information to the DL model which can help in better suppressing the high frequency component in the reference it generates compared to that generated by the embodiment shown in FIG. 2.

Compute structural noise step 304 may be performed in a variety of ways. As mentioned above, data 2A may be the wafer/reticle image of a test die/reticle, and data 2B can be the reference image of neighboring dies/cells or a simulated reference via physics modeling or ML/DL based modeling, including that shown in FIG. 2. Structural noise can then be determined in step 304 as the subtraction between the two inputs. In another option, structural noise can be calculated in step 304 by taking the ratio between the two inputs. For example, computing the structural noises step 304 may include subtracting the specimen image from the specimen reference (2B—2A) or vice versa (2A 0-2B), dividing the specimen image by the specimen reference (2A/2B) or vice versa (2B/2A), etc. The output of this step is structural noises 306. The numbers along the various axes of structural noises 306 shown in FIG. 3 are irrelevant to the understanding of the embodiments described herein and are only shown in FIG. 3 to convey the nature of the visual representation of the computed structural noises shown in this figure.

The computed structural noises may be input to learning of structural noises via self-supervised or unsupervised approach(es) step 308 (also referred to herein as “algorithm Z”) by the computer subsystem in any suitable manner. In this embodiment, therefore, the DL model is also referred to as “algorithm Z.” Other data described herein may also be input to algorithm Z with the computed structural noises. For example, the inputs may include any of the structural noises computed as described above (e.g., 2A-2B, 2B-2A, 2A/2B, 2B/2A, etc.) possibly in combination with data 2B (the specimen reference). Algorithm Z will generate learned structural noises 310 (also referred to herein as “data 2D”). In this manner, the non-defective related structural noises (data 2D) in the computed structural noises (data 2C) can be learned via algorithm Z, and the learned non-defective structural noises are presented as data 2D. As with the computed structural noises, the numbers along the various axes of learned structural noises 310 are irrelevant to the understanding of the embodiments described herein and are only shown in FIG. 3 to convey the nature of the visual representation of the structural noises shown in this figure.

The computed structural noises (data 2C) and the learned structural noises (data 2D) are different in important and perhaps nonobvious ways. For example, the test image of a wafer or reticle (data 2A) contains the defective signal for any defects included in the area on the specimen in which the test image was generated. Data 2B, the nominal or reference image, ideally contains no defective signal. Thus, data 2C, the computed structural noise, itself contains information from both process variations and defects. In contrast, data 2D learned by algorithm Z restores most of the information/noise that is related to process variations but not correlated to defects. By doing so, data 2C and data 2D can be jointly used to extract the cleaner defect signal from the unwanted process variations signals. In other words, the embodiments described herein improve the defect signal which is different from many inspection processes that were mostly focused on how to “clean” the noise. Importantly, by further separating the non-defective structural noise from 2C via the DL model, a better detection sensitivity can be achieved. The results of other processes described herein can be enhanced in a similar manner.

To restate the above from a mathematical perspective, the output 2C is obtained through predetermined, non-predictive approaches such as subtracting/averaging/median images of different dies. The output 2D is predicted by algorithm Z that takes as input 2C. In addition, as mentioned above, data 2D contains learnable non-defective structural noise and little or no defective signal while data 2C contains both.

Data 2C and data 2D can then be input to supervised or unsupervised information determination step 312 (also referred to herein as “algorithm Y”), which generates determined information 314 (also referred to herein as “data 2E”). Data 2C and data 2D may be input to algorithm Y in this embodiment in a number of different ways, e.g., as 2C and 2D, as 2C-2D, as 2C/2D, etc. The inputs to algorithm Y in this embodiment may also include any of the above described inputs in combination with design information and/or specimen reference—data 2B. Step 312, algorithm Y, and data 2E may be further configured as described herein.

In one embodiment, the one or more inputs to the DL model (e.g., algorithm X or algorithm Z shown in FIG. 2 or 3, respectively) also include design information for the specimen and at least the specimen image or the data generated from the specimen image. For example, in the embodiment shown in FIG. 3, the inputs may include data generated from the specimen image, i.e., any of the structural noises computed as described above (e.g., 2A-2B, 2B-2A, 2A/2B, 2B/2A, etc.), possibly in combination with data 2B (the specimen reference), in addition to the design information. Design or computer aided design (CAD) information can be crucial for reference learning or structural noise learning. A design image rendered at the same pixel size as images collected by/from the imaging subsystem or at a smaller pixel size (e.g., 2×, 4×, 8× zoomed design) can be utilized as inputs to algorithm X and algorithm Z. In both instances, the design may also be input to algorithm Y. In other such instances, the design may only be input to algorithm Y (and not algorithm X or algorithm Z as the case may be).

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use in the embodiments described herein well in advance of printing of the design on any physical specimens such as reticles and wafers.

In one such embodiment, the one or more inputs, the design information, and the data generated from the specimen image do not include care area information for the specimen. For example, the embodiments described herein can directly incorporate design information into the information determination process (e.g., as one of the inputs to one or more of algorithm X, algorithm Y, and algorithm Z) without having to generate care areas from the design. For many of the processes described herein this can provide higher sensitivity (because other inputs and/or the determined information can be directly aligned and correlated with the design information) and better time to results (e.g., by eliminating the care area generation process).

“Care areas” as they are commonly referred to in the art are areas on a specimen that are of interest for inspection purposes. Sometimes, care areas are used to differentiate areas on the specimen that are inspected from areas on the specimen that are not inspected in an inspection process. In addition, care areas are sometimes used to differentiate between areas on the specimen that are to be inspected with one or more different parameters. For example, if a first area of a specimen is more critical than a second area on the specimen, the first area may be inspected with a higher sensitivity than the second area so that defects are detected in the first area with a higher sensitivity. Other parameters of an inspection process can be altered from care area to care area in a similar manner.

In another embodiment, the one or more inputs also include care area information for the specimen and at least the specimen image or the data generated from the specimen image. For example, design information can be converted in any suitable manner to care areas such as the NanoPoint or PixelPoint care areas used by some tools commercially available from KLA. The care area information may be used as inputs to either or both of algorithm X (or algorithm Z) and algorithm Y. In this manner, when care area information is available to the embodiments described herein, this information can be input to any of the algorithms described herein in combination with the other inputs to the algorithms.

The data input to the DL model in any of the embodiments described herein may be single mode data or multiple mode data. For example, data 1A shown in FIG. 2 may be single mode or multiple mode imaging data. In another example, data 2A and data 2B shown in FIG. 3 can be single mode or multiple mode imaging data. The single or multiple modes may include any of those described further herein including multi-perspective modes, and single or multiple mode data may be generated and acquired as described further herein. As described below, when the data input to the DL model includes multiple mode data, i.e., multi-mode data, the data for different modes may be input in various ways depending on the configuration of the DL model.

In some embodiments, the specimen image is generated with a first mode of an imaging subsystem, the DL model is configured to generate an additional reference for the specimen from one or more additional inputs that include at least an additional specimen image generated with a second mode of the imaging subsystem or data generated from the additional specimen image, and the computer subsystem is configured for determining additional information for the specimen from the additional reference and at least the additional specimen image or the data generated from the additional specimen image. For example, in the embodiment in which the specimen reference is learned, in a multimode setting, each mode would have a different 1A and 1B. In another example, in the embodiment in which the specimen reference is learned structural noises, in a multimode setting, each mode would have a different 2C and 2D. In essence therefore, each of the steps shown in FIGS. 2 and 3 may be performed multiple times on a per mode basis. In this manner, the DL model may generate output 1 from mode 1 input, output 2 from mode 2 input, and so on for N modes of interest.

In one such embodiment, the specimen image and the additional specimen image or the data generated from the specimen image and the data generated from the additional specimen image are separately input to the DL model at different times. For example, in this case, learning could be performed separately for each use in a multimode setting. In this manner, the DL model may be run independently for each optical mode in a multi-mode setting. In another such embodiment, the specimen image and the additional specimen image or the data generated from the specimen image and the data generated from the additional specimen image are jointly input to the DL model. In this manner, learning can be performed jointly for all modes in a multimode setting by a single DL model. During runtime then, the DL model may be run with multi-mode data jointly. In this case, different 2C images may be stacked together as the inputs.

The computer subsystem may acquire or generate input multi-mode images 200 (or multi-mode structural noises 306 generated from multi-mode specimen images 300 and multi-mode reference images 302) as described further herein, which are input to the multi-mode DL models by the computer subsystem. The input multi-mode images (or the input multi-mode structural noises) may be generated by the imaging subsystem and/or computer subsystem as described further herein.

The computer subsystem is configured for determining information for the specimen from the reference and at least the specimen image or the data generated from the specimen image. In this manner, the computer subsystem is configured for determining information from the learned reference image and the specimen image or the learned structural noises and the computed structural noises. The information determined and the manner in which the reference and at least the specimen image or the data generated from the specimen image are used may vary depending on the process being performed on the specimen. In the embodiments shown in FIGS. 2 and 3, the determining information step may be performed by the computer subsystem using algorithm Y. This algorithm may be part of the one or more components executed by the computer subsystem or may be separate from those components.

In one embodiment, the computer subsystem is not configured for determining information from the reference for any other specimens. For example, the embodiments described herein may be configured for generating a reference on an as-needed basis for any one or more specimens for which the information is being determined. In this manner, for any specimen being inspected, measured, defect reviewed, etc., a different reference may be generated by one of the DL models described herein and used for only that specimen. In other words, reference 1 may be generated for specimen 1 and used for determining information for only specimen 1, reference 2 may be generated for specimen 2 and used for determining information for only specimen 2, and so on. Generating different references for different specimens using one of the DL models described herein may be performed in the same manner described above with respect to multiple modes. Generating and using different predicted references for different specimens may be useful and advantageous when specimens, including even specimens fabricated in the same process and having the same layers formed thereon, can have different and even sometimes dramatically different noise characteristics. In this manner, the embodiments described herein may be more stable to specimen and process variations than those that use the same reference for multiple specimens.

In another embodiment, the computer subsystem is configured for determining information for the specimen from the reference and only the specimen image or the data generated from the specimen image. For example, the embodiments described herein may be configured for generating a reference on an as-needed basis for any one or more specimen images from which the information is being determined. In this manner, for any specimen image being inspected, measured, defect reviewed, etc., a different reference may be generated by one of the DL models described herein and used for only that specimen image. In other words, reference 1 may be generated for specimen image 1 and used for determining information for only specimen image 1, reference 2 may be generated for specimen image 2 and used for determining information for only specimen image 2, and so on. Generating different references for different specimen images using one of the DL models described herein may be performed in the same manner described above with respect to multiple modes. Generating and using different predicted references for different specimen images may be useful and advantageous when specimen images, including even specimen images acquired from different areas on the same specimen (where each area has the same design information) and/or specimen images acquired from different specimens fabricated in the same process and having the same layers formed thereon, can have different and even sometimes dramatically different noise characteristics. In this manner, the embodiments described herein may be more stable to within specimen and process variations than those that use the same reference for multiple specimen images.

In some embodiments, the computer subsystem is configured for determining the information for the specimen by inputting the reference and at least the specimen image or the data generated from the specimen image into a supervised DL model. For example, as shown in FIG. 2, data 1A and data 1B may be input to algorithm Y to perform supervised defect detection in the case of inspection. In a similar manner, as shown in FIG. 3, data 2C and data 2D may be input to algorithm Y to perform supervised defect detection in the case of inspection. The supervised defect detection may be performed as described in U.S. Patent Application Publication No. 2020/0327654 by Zhang et al. published Oct. 15, 2020 in the case of single mode inspection, as described in U.S. Patent Application Publication No. 2021/0366103 by Zhang et al. published Nov. 25, 2021 in the case of multi-mode inspection, or in any other suitable manner known in the art. Both of these publications are incorporated by reference as if fully set forth herein. The embodiments described herein may be further configured as described in these publications.

In another embodiment, the computer subsystem is configured for determining the information for the specimen by inputting the reference and at least the specimen image or the data generated from the specimen image into an unsupervised DL model. For example, if an unsupervised DL model is available for determining any of the information described further herein, the computer subsystem may input the reference and specimen image or computed structural noises in the unsupervised DL model for determining the information. The unsupervised DL model may include any suitable such model known in the art.

In a further embodiment, the computer subsystem is configured for determining the information for the specimen by inputting the reference and at least the specimen image or the data generated from the specimen image into an unsupervised algorithm. In this embodiment, the unsupervised algorithm may be a non-DL algorithm. For example, as shown in FIG. 2, data 1A and data 1B may be input to algorithm Y to perform unsupervised defect detection in the case of inspection. In another example, as shown in FIG. 3, data 2C and data 2D may be input to algorithm Y to perform unsupervised defect detection in the case of inspection. In both of these examples, algorithm Y may include any suitable unsupervised defect detection algorithm such as the MCAT algorithm that is used by some inspection tools commercially available from KLA.

In some embodiments, the information determined for the specimen includes predicted defect locations on the specimen. For example, the embodiments described herein may use a DL based CNN, another DL model, or a non-DL method to predict the location of a defect on a BBP or other image. Each of these models, methods, or algorithms may be supervised or unsupervised. In the most general sense, predicting defect locations on a specimen involves subtracting a non-defective (or as non-defective as a reference can be) image or data from a test image or data and then determining if any differences therebetween are more likely defects or more likely not. Such determining may in the simplest case involve applying a threshold to the differences that separates differences indicative of defects from differences that are not. Obviously, the algorithms described above may be much more complicated and sophisticated than this simple example, which is provided herein merely to convey the nature of predicting defect locations on a specimen. Generally speaking, the references generated as described herein and any other inputs described herein may be used in the same manner for defect detection as any other reference image/data and test image/data. In this manner, the reference image/data and test image/data is not specific to any particular defect detection algorithm or method.

The predicted defect locations may be determined in an inspection process in which a relatively large area on the specimen is scanned by the imaging subsystem and then images generated by such scanning are inspected for potential defects. In addition to predicted defect locations, algorithm Y (in each of the embodiments described herein) may be configured for determining other information for the predicted defect locations such as defect classifications and possibly defect attributes. In general, determining the information may include generating one or more inspection-like results for the specimen. Essentially, therefore, the determining information step may have multiple output to channels, each for a different type of information. The outputs from multiple channels may then be combined into a single inspection results file (e.g., a KLARF file generated by some KLA inspection tools) for the specimen. In this manner, for any one location on the specimen, there may be multiple types of information in the inspection results file.

In a similar manner, the process may be a defect review process. Unlike inspection processes, a defect review process generally revisits discrete locations on a specimen at which a defect has been detected. An imaging subsystem configured for defect review may generate specimen images as described herein, which may be input to the DL model as described herein. The DL model may be trained and configured for generating a specimen reference that can then be used with the specimen image for determining if a defect is actually present at a defect location identified by inspection and for determining one or more attributes of the defect like a defect shape, dimensions, roughness, background pattern information, etc. and/or for determining a defect classification (e.g., a bridging type defect, a missing feature defect, etc.). For defect review applications, algorithm Y may be any suitable defect review method or algorithm used on any suitable defect review tool. While algorithm Y and the various inputs and outputs may be different for defect review use cases compared to inspection, the same DL model may be used for both defect review and inspection (after application-appropriate training). The DL model may otherwise be trained and configured as described above.

As described above, in some embodiments, the imaging subsystem may be configured for metrology of the specimen. In one such embodiment, determining the information includes determining one or more characteristics of a specimen structure in an input image. For example, the DL model described herein may be configured for generating a specimen reference that can be used with a specimen image to determine metrology information for the specimen. The metrology information may include any metrology information of interest, which may vary depending on the structures on the specimen. Examples of such metrology information include, but are not limited to, critical dimensions (CDs) such as line width and other dimensions of the specimen structures. The specimen images may include any images generated by any metrology tool, which may have a configuration such as that described herein or any other suitable configuration known in the art. In this manner, the embodiments described herein may advantageously use a specimen image generated by a metrology tool with a specimen reference generated as described herein for predicting metrology information for the specimen and any one or more specimen structures included in the input image. For metrology applications, algorithm Y may be any suitable metrology method or algorithm used on any suitable metrology tool. While algorithm Y and the various inputs and outputs may be different for metrology use cases compared to inspection, the same DL model may be used for both metrology and inspection (after application-appropriate training). The DL model may otherwise be trained and configured as described above.

The computer subsystem may also be configured for generating results that include the determined information, which may include any of the results or information described herein. The results of determining the information may be generated by the computer subsystem in any suitable manner. All of the embodiments described herein may be configured for storing results of one or more steps of the embodiments in a computer-readable storage medium. The results may include any of the results described herein and may be stored in any manner known in the art. The results that include the determined information may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. For example, results produced by the computer subsystem may include information for any defects detected on the specimen such as location, etc., of the bounding boxes of the detected defects, detection scores, information about defect classifications such as class labels or IDs, any defect attributes determined from any of the images, etc., predicted specimen structure measurements, dimensions, shapes, etc. or any such suitable information known in the art. That information may be used by the computer subsystem or another system or method for performing additional functions for the specimen and/or the detected defects such as sampling the defects for defect review or other analysis, determining a root cause of the defects, etc.

Such functions also include, but are not limited to, altering a process such as a fabrication process or step that was or will be performed on the specimen in a feedback or feedforward manner, etc. For example, the computer subsystem may be configured to determine one or more changes to a process that was performed on the specimen and/or a process that will be performed on the specimen based on the determined information. The changes to the process may include any suitable changes to one or more parameters of the process. In one such example, the computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown) accessible to both the computer subsystem and the semiconductor fabrication system. The semiconductor fabrication system may or may not be part of the system embodiments described herein. For example, the imaging subsystem and/or the computer subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

The embodiments described herein have a number of advantages in addition to those already described. For example, advantages that the embodiments have over currently used methods (such as unsupervised defect detection algorithms that use a frequency measure on marginal or joint probability) include having the ability to directly incorporate multi-mode and multi-perspective data, which enables higher sensitivity. In another example, the embodiments can directly incorporate design data without generating care areas, which enables higher sensitivity and better time to results. In a further embodiment, the embodiments described herein can learn and remove learned non-defective structural noise, which enables higher sensitivity.

The advantages that the embodiments have over currently used supervised ML or DL models include reducing the required number of labeled data points by 10× to 100×, which provides a lower cost of ownership and better time to results. In particular, because the embodiments described herein have a significantly lower requirement on labeled data than other ML and DL based detectors, the embodiments will be easier, cheaper, and faster to setup.

Additional advantages that the embodiments have over general specimen inspection, metrology, defect review, etc. processes include higher signal to noise and sensitivity compared to all existing solutions. In addition, the embodiments described herein are especially applicable to high volume manufacturing (HVM) use cases, as well as research and development to which many leading edge process control processes are limited. For example, the embodiments described herein may be the only ML/DL detection methods that can be applied to HVM use cases. Furthermore, the embodiments described herein can have potentially more stable sensitivity with respect to process variations than other process control methods and systems.

The embodiments described herein are also widely applicable to any process control method that requires a specimen reference. For example, the embodiments can be used for next generation BBP tools to address multi-mode defect detection complexities for current and future process nodes. Likewise, the embodiments can be used in light scattering inspection tools to provide better performance for these tools. The embodiments described herein can be used to push the sensitivity ceiling of these and other tools described herein higher than those currently achievable.

Each of the embodiments described above may be combined together into one single embodiment. In other words, unless otherwise noted herein, none of the embodiments are mutually exclusive of any other embodiments.

Another embodiment relates to a computer-implemented method for determining information for a specimen. The method includes generating a reference for a specimen by inputting one or more inputs into a DL model trained without labeled data. The one or more inputs include at least a specimen image or data generated from the specimen image. The method also includes determining information for the specimen from the reference and at least the specimen image or the data generated from the specimen image. The inputting and determining steps are performed by a computer subsystem, which may be configured according to any of the embodiments described herein.

Each of the steps of the method may be performed as described further herein. The method may also include any other step(s) that can be performed by the imaging subsystem and/or computer subsystem described herein. In addition, the method may be performed by any of the system embodiments described herein.

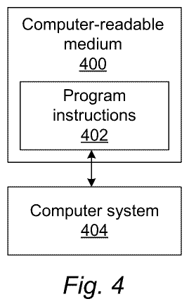

An additional embodiment relates to a non-transitory computer-readable medium storing program instructions executable on a computer system for performing a computer-implemented method for determining information for a specimen. One such embodiment is shown in FIG. 4. In particular, as shown in FIG. 4, non-transitory computer-readable medium 400 includes program instructions 402 executable on computer system 404. The computer-implemented method may include any step(s) of any method(s) described herein.

Program instructions 402 implementing methods such as those described herein may be stored on computer-readable medium 400. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension), Python, Tensorflow, or other technologies or methodologies, as desired.

Computer system 404 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system configured for determining information for a specimen, comprising:
a computer subsystem; and
one or more components executed by the computer subsystem;
wherein the one or more components comprise a deep learning model trained without labeled data and configured to generate a reference for a specimen from one or more inputs comprising at least a specimen image or data generated from the specimen image; and
wherein the computer subsystem is configured for determining information for the specimen from the reference and at least the specimen image or the data generated from the specimen image.

2. The system of claim 1, wherein the deep learning model is further trained in an unsupervised manner.

3. The system of claim 1, wherein the deep learning model is further trained in a self-supervised manner.

4. The system of claim 1, wherein when the one or more inputs comprise the specimen image, the reference comprises a learned reference image.

5. The system of claim 1, wherein when the one or more inputs comprise the data generated from the specimen image and the data generated from the specimen image comprises structural noises, the reference comprises learned structural noises.

6. The system of claim 1, wherein the one or more inputs further comprise design information for the specimen and at least the specimen image or the data generated from the specimen image.

7. The system of claim 1, wherein the one or more inputs further comprise design information for the specimen and at least the specimen image or the data generated from the specimen image, and wherein the one or more inputs, the design information, and the data generated from the specimen image do not comprise care area information for the specimen.

8. The system of claim 1, wherein the one or more inputs further comprise care area information for the specimen and at least the specimen image or the data generated from the specimen image.

9. The system of claim 1, wherein the specimen image is generated with a first mode of an imaging subsystem, wherein the deep learning model is further configured to generate an additional reference for the specimen from one or more additional inputs comprising at least an additional specimen image generated with a second mode of the imaging subsystem or data generated from the additional specimen image, and wherein the computer subsystem is further configured for determining additional information for the specimen from the additional reference and at least the additional specimen image or the data generated from the additional specimen image.

10. The system of claim 9, wherein the specimen image and the additional specimen image or the data generated from the specimen image and the data generated from the additional specimen image are separately input to the deep learning model at different times.

11. The system of claim 9, wherein the specimen image and the additional specimen image or the data generated from the specimen image and the data generated from the additional specimen image are jointly input to the deep learning model.

12. The system of claim 1, wherein the computer subsystem is not configured for determining information from the reference for any other specimens.

13. The system of claim 1, wherein the computer subsystem is further configured for determining information for the specimen from the reference and only the specimen image or the data generated from the specimen image.

14. The system of claim 1, wherein the computer subsystem is further configured for determining the information for the specimen by inputting the reference and at least the specimen image or the data generated from the specimen image into a supervised deep learning model.

15. The system of claim 1, wherein the computer subsystem is further configured for determining the information for the specimen by inputting the reference and at least the specimen image or the data generated from the specimen image into a unsupervised deep learning model.

16. The system of claim 1, wherein the computer subsystem is further configured for determining the information for the specimen by inputting the reference and at least the specimen image or the data generated from the specimen image into an unsupervised algorithm.

17. The system of claim 1, wherein the information determined for the specimen comprises predicted defect locations on the specimen.

18. The system of claim 1, wherein the specimen image is generated by a light-based imaging subsystem.

19. A non-transitory computer-readable medium, storing program instructions executable on a computer system for performing a computer-implemented method for determining information for a specimen, wherein the computer-implemented method comprises:
generating a reference for a specimen by inputting one or more inputs into a deep learning model trained without labeled data, wherein the one or more inputs comprise at least a specimen image or data generated from the specimen image; and
determining information for the specimen from the reference and at least the specimen image or the data generated from the specimen image.

20. A computer-implemented method for determining information for a specimen, comprising:
generating a reference for a specimen by inputting one or more inputs into a deep learning model trained without labeled data, wherein the one or more inputs comprise at least a specimen image or data generated from the specimen image; and
determining information for the specimen from the reference and at least the specimen image or the data generated from the specimen image, wherein said inputting and said determining are performed by a computer subsystem.
